(19) United States
(12) Patent Application Publication
(10) Pub. No.: US 2004/0151558 A1
(43) Pub. Date: Aug. 5, 2004

(54) Threaded fastener

(76) Inventor: Johannes Frederik Klopper, George (ZA)

Correspondence Address: SUGHRUE MION, PLLC, 2100 PENNSYLVANIA AVENUE, N.W., SUITE 800, WASHINGTON, DC, 20037, US

(21) Appl. No.: 10/471,669

(22) PCT Filed: Mar. 15, 2002
(86) PCT No.: PCT/ZA02/00034

(30) Foreign Application Priority Data
Mar. 15, 2001 (ZA) 2001/2161

(51) Int. Cl. F16B 23/00

(52) U.S. Cl. 411/403

(57) ABSTRACT

The invention provides a fastener (10) comprising a shank (11) which terminates in a head formation (12) at one end thereof, the head formation having an outer engagement profile (13) which is adapted to be engaged by drive means to rotate the fastener, and a blind socket (15) whereof the inner surface has an inner engagement profile (14) which is adapted to be engaged by a spigot-type drive means for rotating the fastener, the socket formation terminating in a concave profile at its remote end (15a).

### FIELD OF THE INVENTION

THIS invention relates to a fastener.

DESCRIPTION OF PRIOR ART

Conventional threaded fasteners in the form of bolts are provided with either a hexagonal head which is adapted to be engaged by a conventional drive socket or spanner; or have a suitably profiled recess which is again adapted to be engaged by a conventional drive such as an Allen key, multi splined key or the like. Such conventional bolts fail when the hexagonal head or profiled recess become worn or deformed.

### OBJECT OF THE INVENTION

It is accordingly an object of the present invention to provide a novel threaded fastener which it is believed will exhibit superior qualities relative to conventional bolts.

### SUMMARY OF THE INVENTION

According to the invention, a fastener comprises a shank which terminates in a head formation at one end thereof, the head formation having an outer engagement profile which is adapted to be engaged by drive means to rotate the fastener, and a blind socket whereof the inner surface has an inner engagement profile which is adapted to be engaged by a spigot-type drive means for rotating the fastener, the depth of the socket formation extending axially in the direction of the shank beyond the outer engagement profile. Preferably, the inner engagement profile will be between 10% and 60%, preferably in the order of 30% longer than the outer engagement profile.

Also according to the invention, the socket formation terminates in a concave profile at its remote end. Preferably such concave end zone will extend beyond the collar formation of the head. It has been found that in this way a greater depth can be provided for the inner engagement profile to enable such profile to transmit greater torque.

Also according to the invention, the bolt includes a reinforcing collar formation disposed between the outer engagement profile and the shank.

Further according to the invention, the height of the collar formation comprises between 5% and 50% of the total length of the head formation, preferably 30% thereof. It has been found that a collar formation will considerably strengthen the head formation against tension and tortional forces generated between the head formation and the shank during tightening and loosening.

Still further according to the invention the outer engagement formation is of a polygonal shape in plan, preferably a hexagonal formation in plan, and the collar formation has the same diameter as the outside diameter of the polygonal formation. With such an arrangement the diameter of the shank will be in the order of 66% of the diameter of the collar formation.

In a preferred arrangement the outer engagement formation and in inner engagement formation will be of the same polygonal shape and the sides of the respective outer and inner polygonal shapes will be parallel to one another.

Also according to the invention, the minimum wall thickness between the inner engagement formation and the outer engagement formation is between 10% and 35%, preferably 20%, of the outside diameter of the collar formation.

The invention further provides for the upper profile of the head formation to be beveled or rounded at the entrance to the socket formation and at the outer periphery of the head. Preferably also the junction between the shank and the collar formation will be radiused.

A further feature of the invention comprises the provision of a forging tool for hot forging the head formation of the fastener of the invention comprising a body member defining a central spigot which is adapted to forge the central socket formation of the head of the bolt, and an outer skirt formation surrounding the central spigot and defining an annular chamber between the central spigot and the inner wall of the outer skirt for forging the outer engagement profile of the head formation, and a fluid bleeder duct for bleeding pressurized gas from the annular chamber to the exterior of the tool during the forging process. It has been found that with the above die, the outer engagement profile of the head formation and the inner engagement profile can be formed simultaneously with the required accuracy. It has been found that the fluid bleeder duct will successfully eliminate excessive gas build-up during the forging process. Also according to this aspect of the invention the outer skirt may include a peripheral trimming die for cutting the collar formation of the head to the required diameter.

Also included separately within the scope of the invention is a method of forming the fastener in accordance with the invention comprising the steps of:

providing a billet of a predetermined length;

heating such billet;

enlarging one end of the billet by means of a header operation;

providing the forming die of the invention disclosed above; and

forging the head formation of the bolt in a single operation.

Further according to this aspect of the invention, the method may include the step of trimming the collar formation of the head formation by means of a trimming die. Also according to the invention, the method above includes the step of releasing gaseous pressure build-up in the forming die by means of the bleeder duct.

Also included in the method of the invention is the step of heat treating the forged fastener, whereby the head formation of the fastener is relatively evenly cooled in a quenching process. The heat treatment may further include the step of tempering the quenched fastener characterized in relatively even heating of the head thereof.

Further included within the scope of the invention a method of forming the fastener claimed comprising the steps of:

providing a billet of a predetermined length;

enlarging one end of the billet by means of a header operation;

forming the blind socket with the inner engagement profile in a forging operation;

forming the outer engagement profile and the reinforcing collar formation in a further forging operation.

Preferably the method includes the further step of trimming the collar formation of the head formation by means of a trimming die.

### BRIEF DESCRIPTION OF DRAWINGS

In order more clearly to illustrate the invention, an embodiment thereof is described hereunder purely by way of example without limiting the scope of the invention, with reference to the accompanying drawings wherein:

FIG. 1 is a perspective view of a fastener in the form of a bolt in accordance with the invention;

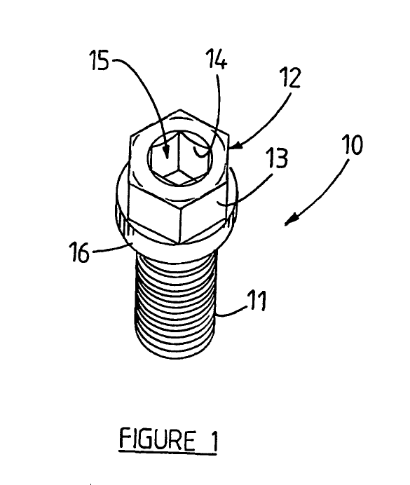

FIG. 2 is a sectioned elevation of the bolt in FIG. 1;

FIG. 3 is a plan view of the head of the bolt in FIG. 1;

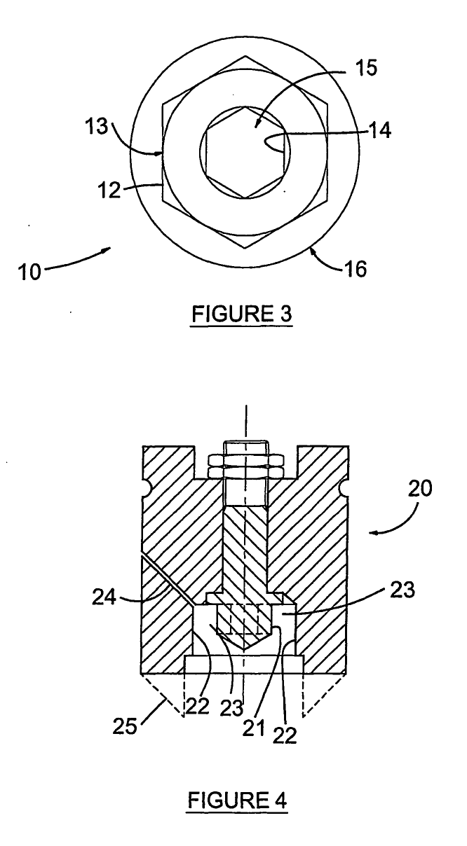

FIG. 4 is a sectioned elevation of a forging tool/die for forming the head of the bolt in FIG. 1; and

FIGS. 5A, 5B 5C and 5D are schematic illustrations of steps in a method of cold forging the bolt in FIG. 1.

### DETAILED DESCRIPTION OF DRAWINGS

Referring to the drawings, a bolt 10 in accordance with the invention comprises a threaded shank 11 which terminates at its one end in a head formation 12. It is a feature of the invention that the head formation 12 comprises an outer engagement profile 13, in the form of a plurality of flat surfaces arranged about the outer circumference of the head 12 to define a polygonal shape in plan view, preferably a hexagonal profile. The head formation 12 further defines an inner engagement profile 14 within a concentric socket 15 in the head formation 12. The inner engagement profile 14 could likewise be in the form of a polygonal arrangement of adjacent flat surfaces, preferably a hexagonal profile. Alternatively, the inner engagement profile could be in the form of grooves, splines, or the like which are adapted to be engaged by a correspondingly formed tool.

In a preferred arrangement, the flat surfaces of the inner engagement profile 14 and the outer engagement profile 13, will be parallel to one another. It has been found that in this way maximum wall thickness between the flat surfaces and consequently maximum torsional strength is achieved.

Preferably, the minimum wall thickness between the inner engagement formation 14 and the outer engagement formation 13, will be between 10% and 35%, of the outer diameter of the outer engagement profile 13.

The head formation 12 of the bolt 10 further includes a reinforcing collar 16 at the junction between shank 11, and the outer engagement profile 13. The height of the reinforcing collar 16, is between 5% and 50% of the total length of the head formation 12, preferably 30% thereof. The reinforcing collar 16 provides a bearing surface 16a for the bolt at the interface between the head 12 and the shank 11, and also acts to prevent shearing thereof during tightening or loosing of the bolt 10.

The collar formation 16 is preferably substantially the same diameter as a conventional cap screw which has a cylindrical, circular head formation with a profiled socket formation therein. With such an embodiment, the diameter of the shank 11 will be approximately 66% of the diameter of the collar 16. The arrangement of the invention thus provides a significant saving of the material at the head formation 12, because of the engagement profile 13 formed thereon. A materials saving of between 5% and 10% is achieved over a conventional cap screw.

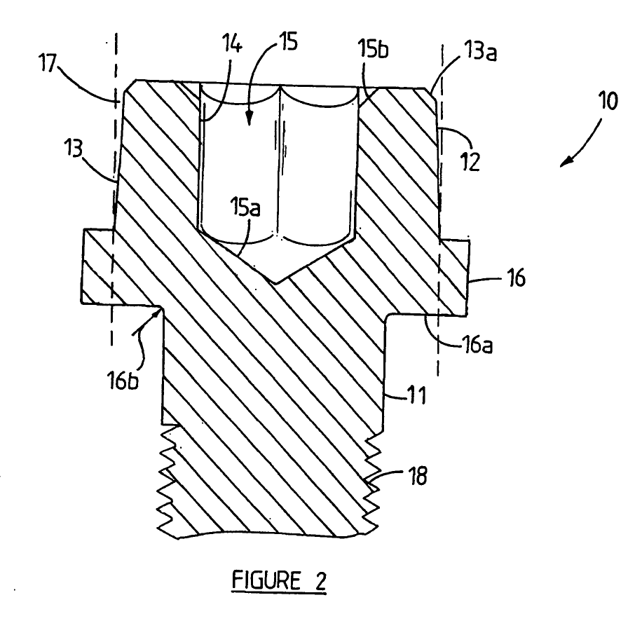

It is a further feature of the invention that the socket 15 and the inner engagement profile 14 extend axially in the direction of the shank 11, beyond the outer engagement profile 13. Preferably, the inner engagement profile will be between 10% and 60%, preferably in the order of 30% longer than the outer engagement profile. The socket formation 15 thus extends into the zone of the reinforcing collar 16, FIG. 2. It has been found that the reinforcing collar 16 will add sufficient tortional strength to the head 12 of the bolt 10 to permit such extended deeper socket formation 15. The advantage of the extended socket formation 15 is that a larger gripping area is available for a tool, not shown, thus permitting substantially more torque to be transmitted to the bolt 10 via the internal engagement formation 14.

With the above arrangement, the invention also provides that the inner end zone 15a of the socket formation 15 will be concave, preferably tapered at an angle of around 45°. It has been found that such concave or tapered end in the zone 15a of the socket formation 15, will substantially enhance the tortional strength of the head 12 of the bolt 10.

From a structural point of view, the invention further provides for the outermost periphery 13a of the head 12 to be beveled at around 45°, as well as the entrance 15b to the socket formation 15. It is further provided for the junction 16b between the collar formation 16 and the threaded shank 11 to be radiused.

The shank 11 of the bolt 10 can be provided with a variety of threads or similar gripping formations whereby the bolt 10 may be tightened upon rotation thereof in one direction, and loosened upon rotation in a reverse direction.

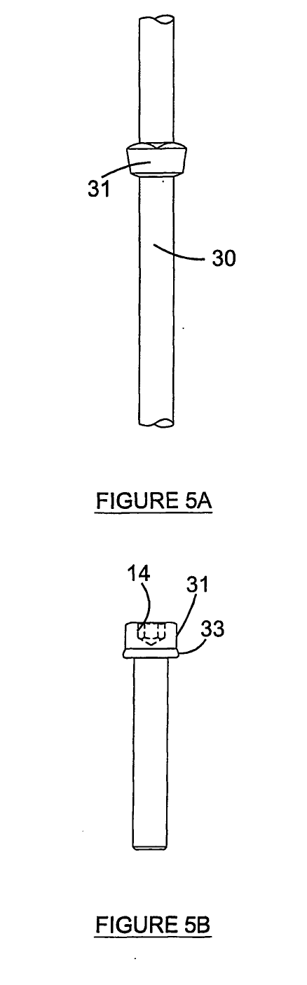

Also included within the scope of the invention is a forging tool or die 20 for forming the head 12, bolt 10 of the invention. With reference to FIG. 4, such a die comprises a central spigot 21 which is adapted to form the blind socket 15 in the head 10, and an outer skirt 22 spaced from the spigot 21, for forming the outer profile 13 of the head 12. An annular chamber 23 is thus defined between the outer skirt 22 and the central spigot 21 and it is a feature of the invention that a bleeder duct 24 will lead from the annular space 23 to the exterior of the die 20, to relieve gas pressure which may build-up in the annular space 23 during the forming process. It has been found that the bleeder duct 24 permits accurate forming of the head 12 in a single forging process. It has also been found desirable that the outer engagement formation 13 should be provided with a slight relief angle shown at 17, FIG. 2. For this purpose, the skirt 22 will flare outwardly to a slight degree to facilitate release of the forging die 20 from the bolt 10.

The invention further contemplates that the collar 16 could be trimmed after or during the forging process. Such trimming could thus take place during forging of the head 10, and in such a case the skirt formation 22 of the die 20 could terminate in a circumferential trimming blade shown in broken lines at 25.

Use of the forging die 20 in a method of forging, whereby pressurized gasses in the annular chamber 23 are released during the forging process, is included within the scope of the invention. Thus, in one example, the bolt 10 can be formed as follows:

a cylindrical billet of material will be cut to the required length. For larger bolts the billet could be heated to forging temperature, while smaller bolts could be cold forged;

in a header operation, material at one end of the billet will be enlarged;

thereafter, the head 12 of the bolt 10 will be formed in a forging process, by means of the die 20 of the invention described above;

as mentioned above, this step can be performed in a single operation;

simultaneously or thereafter, the collar 16 will be trimmed by means of a trimming die;

After the above steps, a thread 18 or the like can be cut on, on rolled onto, the shank 11 of the bolt 10.

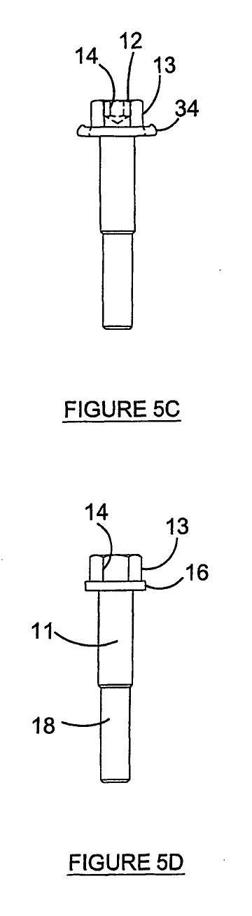

FIGS. 5a to 5d illustrate the various steps in a method of forming the bolt 10 in a cold forging operation. In FIG. 5a, a cylindrical billet of material which has been cut to the required length is enlarged at the one end thereof 31 in a header operation. In FIG. 5B, the enlarged end 31 is stamped, in a forging operation to form the blind socket and the inner engagement profile 14. At this stage also a preliminary collar formation 33 is formed.

In FIG. 5c, the outer engagement profile of 13 of the bolt is stamped together with an enlarged collar formation 34, in a forging operation.

Further, in FIG. 5d, the collar formation 16 is trimmed to the required diameter.

During the above processes, the shank 11 of the bolt, and the threads 18 therefore will be formed in a conventional manner.

It has been found that heat treatment of the bolt 10 is particularly effective, since the head 12 of the bolt does not have excessively thick sections due to the formation of the internal spigot 15. Thus during heat treatment, when the bolt 10 is quenched, a relative even cooling of the head 12 of the bolt 10 will take place. Also with tempering, a relatively even heating of the head 12 of the bolt 10 will take place. Finally, the bolt 10 can be subjected to shot blast stress relieving and cleaning if required.

The results of some tests conducted on the bolt 10 are set out below:—

TEST I

The test sample consisted of twelve M30×140 mm grade 12,9 bolts. The bolt heads were of a hexagonal cap screw type with a hexagonal external head.

The object of the tests was to determine whether the sample complied with ISO 898-1 :1988 (and South African Bureau of Standards 1700-5-1 1996) “Fasteners: General requirements and mechanical properties”; including Rockwell Hardness and Proof Load.

Test Results

a) ROCKWELL HARDNESS

Specimen A Actual (Average of 3 readings) 40,4 Specified 39-44

b) PROOF LOAD

After proof load of 544 kN was held axially for 15 seconds on specimens B and C, it was still possible to unscrew the bolt by hand and there was no permanent distortion.

TEST II

A batch of hexagon head bolts were submitted for torque testing. The bolts heads were of hexagon cap screw type with a hexagon external head and hence sockets and Allen keys were used. Torque settings for each bolt are set out below:

(i) 1×M16 Bolt-Required torque setting being 385 Nm

(ii) 1×M20 Bolt-Required torque setting being 750 Nm

(iii) 2×M24 Bolt-Required torque setting being 1290 Nm

(iv) 2×M30 Bolt (Course thread)-Required torque setting being 2585 Nm

(v) 2×M30 Bolt (Fine thread)-Required torque setting being 2585 Nm

Method 1 Torque Setting

Prior to the test each bolt was measured and a line scribed on the shank of each bolt to check for torsional deformation after the torque had been applied. Suitable sleeves were located in between each nut and bolt. Each assembly was mounted on to a vice.

A torque of 1000 Nm and less was applied using a calibrated torque wrench. Four M30 bolts and two M24 bolts were in turn installed in 100 kN Amsler Universal testing machine using a suitable test rig. A gradually increasing load was applied to the Allen key until the predetermined torque was obtained. Each bolt was visually inspected and the measurements checked.

Method 2—Torque Setting

Subsequently the M30 and M24 bolts were mounted on to a vice with a torque of 1000 Nm applied five times to each assembly. A predetermined torque was similarly applied five times to the M20 and M16 bolts.

Test Results

| | |
|---|---|
| Visual Examination | No visible defects |
| Permanent Deformation over Measured distances | None |

The advantages of the bolt 10 of the invention will be understood by persons skilled in the art. It will be understood that the dual engagement profiles of the head 12 of the bolt 10 will permit a combination tool, not shown, to be utilized for rotating the bolt.

Also from a utility point of view, the bolt 10 of the invention has been shown to be considerably stronger than conventional bolts for purpose of tightening and loosening. Moreover, the collar formation 16 of the bolt 10 providing a bearing surface while also having the strengthening function. The dual engagement profiles of the head, also allows various permutations of the sizes thereof and permits the use of various types of engagement tools. For example, one engagement surface could be of a metric measurement, while the other is of an imperial measurement etc.

From a manufacturing point of view, the bolt of the invention has a materials savings aspect, since the material in the head is less than that of a conventional bolt or cap screw. A saving of approximately 5% to 10% is achieved. The bolt of the invention is also readily formed in a forging process, and more effective heat treatment can be applied thereto as described above.

Doubtless many variations of the invention exist without departing from the principles set out in the consistory clauses.

1. A fastener comprising a shank which terminates in a head formation at one end thereof, the head formation having an outer engagement profile which is adapted to be engaged by drive means to rotate the fastener, and a blind socket whereof the inner surface has an inner engagement profile which is adapted to be engaged by a spigot-type drive means for rotating the fastener, the socket formation terminating in a concave profile at its remote end.

2. The fastener according to claim 1 wherein the depth of the socket formation extends axially in the direction of the shank beyond the outer engagement profile.

3. The fastener according to claim 2 wherein the inner engagement profile is between 10% to 60% longer than the outer engagement profile.

4. The fastener according claim 2 or claim 3 wherein the inner engagement profile is 30% longer than the outer engagement profile.

5. The fastener according to any one of claims 2 to 4 wherein the head formation includes a reinforcing collar formation disposed between the outer engagement profile and the shank, and the concave profile extends beyond the collar formation of the head.

6. The fastener according to any one of claims 1 to 5 wherein the head formation includes a reinforcing collar formation disposed between the outer engagement profile and the shank.

7. The fastener according to claim 6 wherein the height of the collar formation comprises between 5% and 50% of the total length of the head formation.

8. The fastener according to claim 6 or claim 7 wherein the height of the collar formation comprises 30% of the total length of the head formation.

9. The fastener according to any one of claims 1 to 8 wherein the outer engagement formation is a polygonal shape in plan and the collar formation has the same diameter as a circle encompassing the polygonal formation.

10. The fastener according to any one of claims 5 to 9 wherein the diameter of the shank is in the order of 66% of the diameter of the collar formation.

11. The fastener according to any one of claims 1 to 10 wherein the outer engagement formation and the inner engagement formation are of the same polygonal shape in plan, and the sides of the respective outer and inner polygonal shapes are parallel to one another.

12. The fastener according to claim 11 wherein the minimum wall thickness between the outer engagement formation and the inner engagement formation is between 10% and 35% of the outer diameter of the collar formation.

13. The fastener according to claim 11 or claim 12 wherein the minimum wall thickness between the outer engagement formation and the inner engagement formation is 20% of the outer diameter of the collar formation.

14. The fastener according to any one of claims 1 to 13 wherein the head formation is beveled or rounded at the entrance of the socket formation.

15. The fastener according to any one of claims 1 to 14 wherein the upper periphery of the head formation is beveled or rounded.

16. The fastener according to any one of claims 1 to 15 wherein the junction between the shank and the collar formation is radiused.

17. A fastener substantially as herein described and exemplified with reference to the accompanying drawings.

18. A forging tool for hot forging the head formation of the fastener claimed in any one of claims 1 to 17 comprising a body member defining a central spigot which is adapted to forge the central socket formation of the head of the bolt, and an outer skirt formation surrounding the central spigot and defining an annular chamber between the central spigot and the inner wall of the outer skirt for forging the outer engagement profile of the head formation, and a fluid bleeder duct for bleeding pressurized gas from the annular chamber to the exterior of the tool during the forging process.

19. The forging tool according to claim 18 wherein the outer skirt includes a peripheral trimming die for trimming the collar formation of the head formation.

20. A forging tool for hot forging the head formation of the fastener claimed in any one of claims 1 to 17 substantially as herein described and exemplified with reference to the accompanying drawings.

21. A method of forming the fastener claimed in any one of claims 1 to 17 comprising the steps of:
providing a billet of a predetermined length;
heating such billet;
enlarging one end of the billet by means of a header operation;
providing the forming die of the invention claimed in any one of claims 18 to 20 disclosed above; and
forging the head formation of the bolt in a single operation.

22. The method according to claim 21 including the step of trimming the collar formation of the head formation by means of a trimming die.

23. The method according to claim 21 or claim 22 including the step of releasing gaseous pressure build-up in the forming die by means of the bleeder duct.

24. The method according to any one of claims 21 to 23 including the step of heat treating the forged fastener, whereby the head formation is quenched providing a relatively even cooling thereof.

25. The method according to any one of claims 21 to 24 including the step of tempering the forged fastener comprising the step of subjecting the head formation of the fastener to a heating cycle in a heating oven whereby a relatively even heating of the head formation results.

26. A method of forming the fastener claimed in any one of claims 1 to 17 substantially as herein described and exemplified with reference to the accompanying drawings.

27. A method of forming the fastener claimed in any one of claims 1 to 17 comprising the steps of:
providing a billet of a predetermined length;
enlarging one end of the billet by means of a header operation;
forming the blind socket having the inner engagement profile in a forging operation;
forming the outer engagement profile and the reinforcing collar formation in a further forging operation.

28. The method according to claim 27 including the step of trimming the collar formation of the head formation to a required diameter by means of a trimming die.

29. The method of forming a fastener according to claim 27 substantially as herein described and exemplified with reference to the accompanying drawings.

30. A method of heat treating the fastener claimed in any one of claims 1 to 17 comprising the steps of heat treating the forged fastener, whereby the head formation is quenched providing a relatively even cooling thereof.

31. The method according to claim 30 claiming the method of heat treating the fasteners claimed in any one of claims 1 to 17 comprising the steps of subjecting the head formation of the fastener to a heating cycle in a heating oven whereby a relatively even heating of the head formation results.

32. A method of heat treating the fastener claimed in any one of claims 1 to 17 substantially as herein described and exemplified with reference to the accompanying drawings.
